(19) United States
(12) Patent Application Publication
(10) Pub. No.: US 2020/0186457 A1
(43) Pub. Date: Jun. 11, 2020

(54) Test System For Rack And Electronic Devices Disposed In The Rack And Method Thereof

(71) Applicants: Inventec (Pudong) Technology Corporation, Shanghai (CN); Inventec Corporation, Taipei City (TW)

(72) Inventor: Shu-Mei Zhao, Shanghai (CN)

(21) Appl. No.: 16/228,396

(22) Filed: Dec. 20, 2018

(30) Foreign Application Priority Data
Dec. 11, 2018 (CN) 201811509413.7

(51) Int. Cl. H04L 12/26; H04L 12/24

(52) U.S. Cl. CPC H04L 43/50; H04L 41/14

(57) ABSTRACT

A test system and a test method for a rack and electronic devices disposed in the rack are provided. A test server performs data conversion processing on standalone testing information to make the standalone testing information converted into standalone testing information for the rack. The test server transmits rack testing information to an RMC board corresponding to the rack or transmits the standalone testing information for the rack to the electronic devices through connection nodes corresponding to the rack, so that the RMC board carries out rack testing of the rack according to the rack testing information, and each electronic device can perform standalone testing thereof according to the standalone testing information for the rack. Therefore, the technical effect of testing the rack and the electronic devices disposed in the rack is achieved.

### BACKGROUND OF THE INVENTION

### 1. Field of the Invention

The present invention relates to a test system and a method thereof. In particular, the invention pertains to a test system and a method thereof, wherein a test server performs data conversion processing on standalone testing information to make the standalone testing information converted into standalone testing information for a rack, so that the rack and electronic devices disposed in the rack can be tested.

### 2. Description of the Related Art

The rack is provided for disposing electronic devices to save the space for the electronic devices. The testing of the rack generally includes the testing for the function of the rack itself and the testing for the control and connection of the rack to the electronic devices, and does not include the testing for the electronic devices disposed in the rack. The testing of the electronic devices requires additional testing.

The system architecture for the testing of the rack is different from that for the testing of the electronic devices, so that the testing method for the rack and the testing method for the electronic devices are different. That is, the testing of the electronic devices cannot be performed through the rack.

In summary, it can be seen that there is a problem in the prior art that the rack and the electronic devices disposed in the rack are tested separately. Therefore, it is necessary to propose an improved technical solution to solve this problem.

### SUMMARY OF THE INVENTION

In view of the prior art, there is a problem that the rack and the electronic devices disposed in the rack are tested separately, and the present invention discloses a test system for a rack and electronic devices disposed in the rack and a method thereof.

The test system for the rack and electronic devices disposed in the rack disclosed in the present invention includes the rack and a test server, and the test server includes a receiving module, a rack information module, a device information module, an inquiring module, a conversion module and a transmission module.

The rack has a plurality of connection nodes electrically connected to the electronic devices corresponding thereto and a remote monitoring and control board (RMC board). The plurality of connection nodes perform testing and controlling through the RMC board, the RMC board carries out rack testing of the rack according to rack testing information, and each electronic device performs standalone testing thereof according to standalone testing information for the rack.

The receiving module of the test server is configured to receive a rack testing command or a standalone testing command, and the rack information module of the test server is configured to obtain rack information according to a rack serial number in the rack testing command or in the standalone testing command. The device information module of the test server is configured to obtain MAC information of the electronic devices corresponding to the plurality of connection nodes from plurality of connection nodes when the receiving module receives the standalone testing command. The inquiring module of the test server is configured to inquire the rack testing information according to the rack testing command and the rack information, or inquire standalone testing information according to the standalone testing command and the MAC information of electronic devices. The conversion module of the test server is configured to perform data conversion processing on the standalone testing information to make the standalone testing information converted into the standalone testing information for the rack. The transmission module of the test server is configured to transmit the rack testing information to the RMC board corresponding to the rack, or transmit the standalone testing information for the rack to the electronic devices corresponding to the plurality of connection nodes through the plurality of connection nodes corresponding to the rack.

The test method for the rack and electronic devices disposed in the rack disclosed in the present invention includes the following steps: providing the rack having a plurality of connection nodes electrically connected to the electronic devices corresponding thereto and a RMC board, wherein the plurality of connection nodes perform testing and controlling through the RMC board; providing a test server connected to the rack; then, receiving, by the test server, a rack testing command or a standalone testing command; obtaining. by the test server, rack information according to a rack serial number in the rack testing command or in the standalone testing command; obtaining, by the test server, MAC information of the electronic devices corresponding to the plurality of connection nodes from the plurality of connection nodes when receiving, by the test server, the standalone testing command; inquiring, by the test server; rack testing information according to the rack testing command and the rack information, or inquiring, by the test server, standalone testing information according to the standalone testing command and the MAC information of electronic devices; performing, by the test server, data conversion processing on the standalone testing information to make the standalone testing information converted into standalone testing information for the rack; transmitting, by the test server, the rack testing information to the RMC board corresponding to the rack, or transmitting, by the test server, the standalone testing information for the rack to the electronic devices corresponding to the plurality of connection nodes through the plurality of connection nodes corresponding to the rack; carrying out, by the RMC board, rack testing of the rack according to the rack testing information; and performing, by each electronic device, standalone testing thereof according to the standalone testing information for the rack.

The system and method disclosed by the present invention are as above, and the difference from the prior art is that when the test server receives the rack testing command or the standalone testing command, the test server obtains the rack information according to the rack serial number in the rack testing command or in the standalone testing command, and the test server performs data conversion processing on the standalone testing information to make the standalone testing information converted into the standalone testing information for the rack, and the test server transmits the rack testing information to the RMC board corresponding to the rack, or transmits the standalone testing information for the rack to the electronic devices corresponding to the plurality of connection nodes through the plurality of connection nodes corresponding to the rack, so that the RMC board carries out rack testing of the rack according to the rack testing information and each electronic device performs standalone testing thereof according to the standalone testing information for the rack.

By aforementioned technology means, the present invention can achieve the technical effect that the rack and electronic devices disposed in the rack can be tested.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a test system for a rack and electronic devices disposed in the rack according to the present invention.

FIG. 2A and FIG. 2B are flow charts showing a test method for the rack and electronic devices disposed in the rack according to the present invention.

FIG. 3 is a system architecture diagram of the test method for the rack and electronic devices disposed in the rack according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be understood that when an element is referred to as being “connected to” or “coupled to” another element, it can be directly connected or coupled to the other element, or intervening elements may be present. In contrast, when an element is referred to as being “directly connected to” or “directly coupled to” another element, there are no intervening elements present.

In addition, unless explicitly described to the contrary, the word “comprise” and variations such as “comprises” or “comprising”, will be understood to imply the inclusion of stated elements but not the exclusion of any other elements.

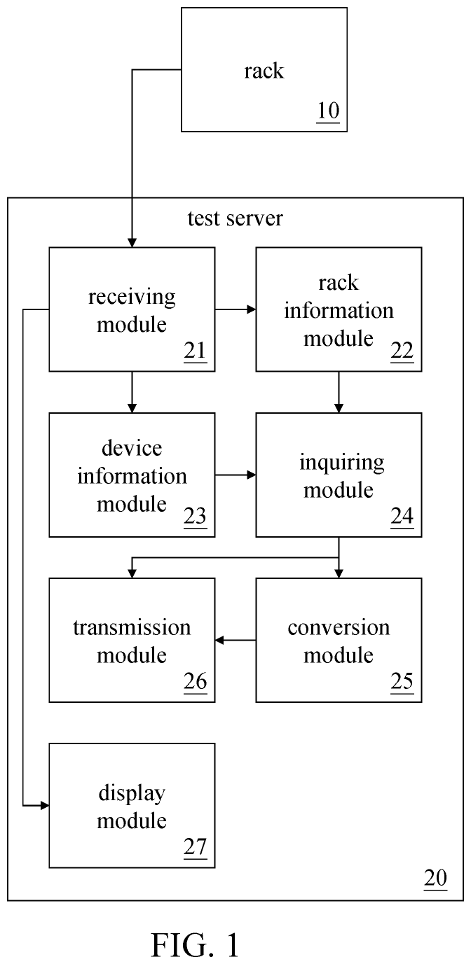

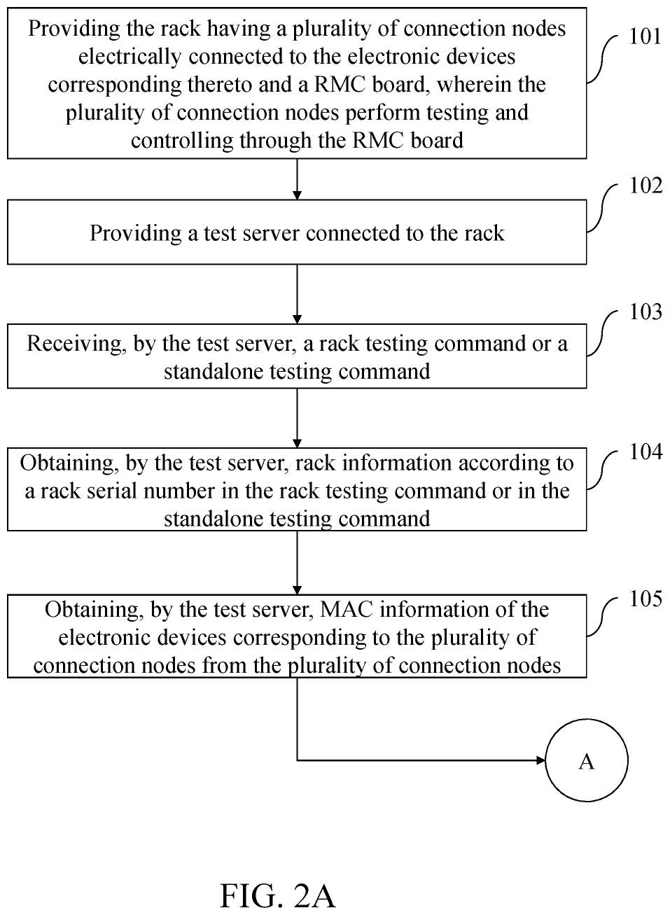

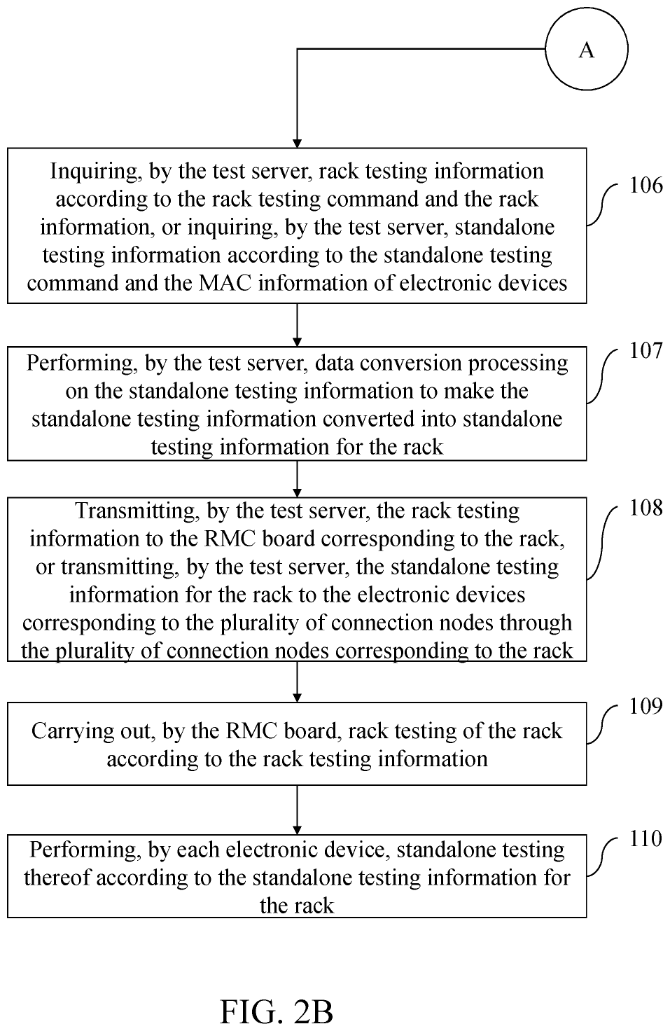

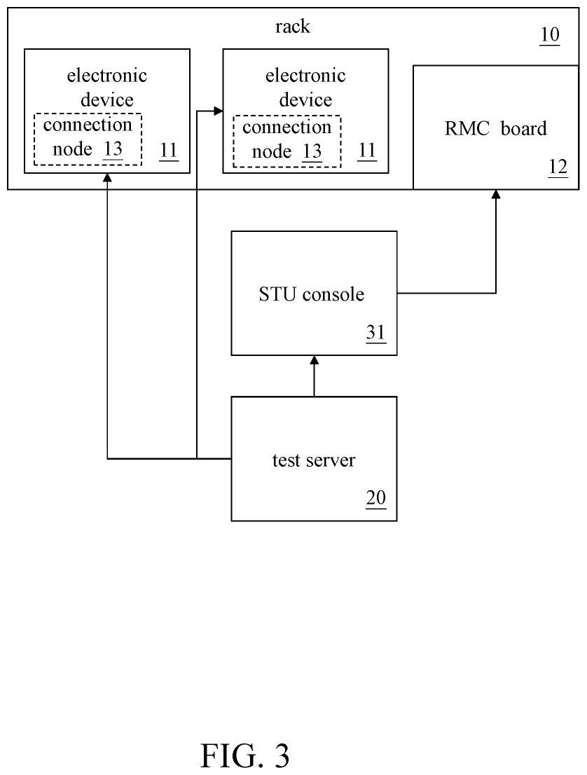

Hereinafter, an operational system and method in accordance with an embodiment of the present invention will be described below with reference to FIG. 1, FIG. 2A, FIG. 2B, and FIG. 3. FIG. 1 is a block diagram of a test system for a rack and electronic devices disposed in the rack according to the present invention, FIG. 2A and FIG. 2B are flow charts showing a test method for the rack and electronic devices disposed in the rack according to the present invention, and FIG. 3 is a system architecture diagram of the test method for the rack and electronic devices disposed in the rack according to the present invention.

The test system for the rack and electronic devices disposed in the rack disclosed in the present invention comprises the rack 10 and a test server 20, and the test server 20 comprises a receiving module 21, a rack information module 22, a device information module 23, an inquiring module 24, a conversion module 25 and a transmission module 26.

The rack 10 has a plurality of connection nodes 13 electrically connected to the electronic device 11 corresponding thereto and a RMC board 12, and the plurality of connection nodes 13 perform testing and controlling through the RMC board 12 (step 101). The RMC board 12 is used to carry out rack testing of the rack 10 according to rack testing information, and each electronic device 11 performs standalone testing thereof according to standalone testing information for the rack.

The test server 20 and the rack 10 establish a connection through a wired transmission mode or a wireless transmission mode (step 102), wherein the foregoing wired transmission mode is, for example, a cable network or a fiber network, and the foregoing wireless transmission mode is , for example, Wi-Fi or mobile communication network. These are for illustrative purposes only and are not intended to limit the scope of application of the invention.

The receiving module 21 of the test server 20 receives a rack testing command from an operation interface provided by the test server 20 (step 103), and the rack information module 22 of the test server 20 obtains rack information according to a rack serial number in the rack testing command (step 104). The rack information is, for example, the model of the rack, the information of the RMC board 12, the serial number of the connection node 13, which are merely exemplified herein, and are not limited thereto.

The inquiring module 24 of the test server 20 is configured to inquire the rack testing information according to the rack testing command and the rack information (step 106). The transmission module 26 of the test server 20 is configured to transmit the rack testing information to the RMC board 12 corresponding to the rack 10 (step 108), whereby the RMC board 12 of the rack 10 carries out rack testing of the rack 10 according to rack testing information (step 109).

The receiving module 21 of the test server 20 receives the standalone testing command from the operation interface provided by the test server 20 (step 103), and the rack information module 22 of the test server 20 obtains rack information according to a rack serial number in the standalone testing command (step 104).

The device information module 23 of the test server 20 obtains MAC information of the electronic devices 11 corresponding to the plurality of connection nodes 13 from plurality of connection nodes 13 (step 105). The inquiring module 24 of the test server 20 is configured to inquire the standalone testing information according to the standalone testing command and the MAC information of electronic devices 11 (step 106). The conversion module 25 of the test server 20 performs data conversion processing on the standalone testing information to make the standalone testing information converted into the standalone testing information for the rack (step 107). The transmission module 26 of the test server 20 transmits the standalone testing information for the rack to the electronic devices 11 corresponding to the plurality of connection nodes 13 through the plurality of connection nodes 13 corresponding to the rack 10 (step 108), whereby each electronic device 11 performs standalone testing thereof according to standalone testing information for the rack (step 110).

Each electronic device 11 performs standalone testing thereof according to the standalone testing information for the rack after each electronic device 11 is activated through the RMC board 12. The test server 20 further makes the RMC board 12 carry out the rack testing of the rack 10 according to the rack testing information through a STU console 31 corresponding to the rack 10. The conversion module 25 performs conversion of rack data structure processing on the standalone testing information to make the standalone testing information converted into the standalone testing information for the rack. The receiving module 21 further receives instant testing data or testing result data from the RMC board 12, and a display module 27 further included in the test server 20 is used to display the instant testing data or the testing result data.

In summary, it can be seen that the difference between the present invention and the prior art is that when the test server receives the rack testing command or the standalone testing command, the test server obtains the rack information according to the rack serial number in the rack testing command or in the standalone testing command, and the test server performs data conversion processing on the standalone testing information to make the standalone testing information converted into the standalone testing information for the rack, and the test server transmits the rack testing information to the RMC board corresponding to the rack, or transmits the standalone testing information for the rack to the electronic devices corresponding to the plurality of connection nodes through the plurality of connection nodes corresponding to the rack, so that the RMC board carries out rack testing of the rack according to the rack testing information and each electronic device performs standalone testing thereof according to the standalone testing information for the rack.

Above-mentioned technical means can be used to solve the problem that the rack and the electronic devices disposed in the rack are tested separately, and the technical effect of testing the rack and the electronic devices disposed in the rack is achieved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A test system for a rack and electronic devices disposed in the rack, comprising:
the rack, which has a plurality of connection nodes electrically connected to the electronic devices corresponding thereto and a remote monitoring and control board (RMC board), wherein the plurality of connection nodes perform testing and controlling through the RMC board, the RMC board carries out rack testing of the rack according to rack testing information_{;} and each electronic device performs standalone testing thereof according to standalone testing information for the rack; and
a test server, which is connected to the rack and further comprising:
a receiving module, configured to receive a rack testing command or a standalone testing command;
a rack information module, configured to obtain rack information according to a rack serial number in the rack testing command or in the standalone testing command;
a device information module, configured to obtain MAC information of the electronic devices corresponding to the plurality of connection nodes from plurality of connection nodes when the receiving module receives the standalone testing command;
an inquiring module, configured to inquire the rack testing information according to the rack testing command and the rack information, or inquire standalone testing information according to the standalone testing command and the MAC information of electronic devices;
a conversion module, configured to perform data conversion processing on the standalone testing information to make the standalone testing information converted into the standalone testing information for the rack; and
a transmission module, configured to transmit the rack testing information to the RMC board corresponding to the rack, or transmit the standalone testing information for the rack to the electronic devices corresponding to the plurality of connection nodes through the plurality of connection nodes corresponding to the rack.

2. The test system according to claim 1, wherein each electronic device performs standalone testing thereof according to the standalone testing information for the rack after each electronic device is activated through the RMC board.

3. The test system according to claim 1, wherein the test server is further configured to make the RMC board carry out the rack testing of the rack according to the rack testing information through a STU console corresponding to the rack.

4. The test system according to claim 1, wherein the conversion module performs conversion of rack data structure processing on the standalone testing information to make the standalone testing information converted into the standalone testing information for the rack.

5. The test system according to claim 1, wherein the receiving module further receives instant testing data or testing result data from the RMC board, and a display module further included in the test server is used to display the instant testing data or the testing result data.

6. A test method for a rack and electronic devices disposed in the rack, comprising:
providing the rack having a plurality of connection nodes electrically connected to the electronic devices corresponding thereto and a RMC board, wherein the plurality of connection nodes perform testing and controlling through the RMC board;
providing a test server connected to the rack;
receiving, by the test server, a rack testing command or a standalone testing command;
obtaining, by the test server, rack information according to a rack serial number in the rack testing command or in the standalone testing command;
obtaining, by the test server, MAC information of the electronic devices corresponding to the plurality of connection nodes from the plurality of connection nodes when receiving, by the test server, the standalone testing command;
inquiring, by the test server, rack testing information according to the rack testing command and the rack information, or inquiring, by the test server, standalone testing information according to the standalone testing command and the MAC information of electronic devices;
performing, by the test server, data conversion processing on the standalone testing information to make the standalone testing information converted into standalone testing information for the rack;
transmitting, by the test server, the rack testing information to the RMC board corresponding to the rack, or transmitting, by the test server, the standalone testing information for the rack to the electronic devices corresponding to the plurality of connection nodes through the plurality of connection nodes corresponding to the rack;
carrying out, by the RMC board, rack testing of the rack according to the rack testing information; and
performing, by each electronic device, standalone testing thereof according to the standalone testing information for the rack.

7. The test method according to claim 6, wherein each electronic device performs standalone testing thereof according to the standalone testing information for the rack after each electronic device is activated through the RMC board.

8. The test method according to claim 6, wherein the test server is further configured to make the RMC board carry out the rack testing of the rack according to the rack testing information through a STU console corresponding to the rack.

9. The test method according to claim 6, wherein the conversion module performs conversion of rack data structure processing on the standalone testing information to make the standalone testing information converted into the standalone testing information for the rack.

10. The teat method according to claim 6, wherein the receiving module further receives instant testing data or testing result data from the RIM board, and a display module further included in the test server is used to display the instant testing data or the testing result data.
